(19) United States
(12) Patent Application Publication
(10) Pub. No.: US 2024/0396281 A1
(43) Pub. Date: Nov. 28, 2024

(54) Absorbing Optical Switch for High Fluence Laser Pulse

(71) Applicants: Robert O. Hunter, JR., Aspen, CO (US); Richard B. Holmes, Shingle Springs, CA (US)

(72) Inventors: Robert O. Hunter, JR., Aspen, CO (US); Richard B. Holmes, Shingle Springs, CA (US)

(73) Assignee: Innoven Energy LLC, Solana Beach, CA (US)

(21) Appl. No.: 18/674,007

(22) Filed: May 24, 2024

Related U.S. Application Data
(60) Provisional application No. 63/469,015, filed on May 25, 2023.

(51) Int. Cl. H01S 3/00; H01S 3/038; H01S 3/097; H01S 3/102; H01S 3/22; H01S 3/225; H01S 3/30

(52) U.S. Cl. CPC H01S 3/0057; H01S 3/0381; H01S 3/0382; H01S 3/09707; H01S 3/1024; H01S 3/2222; H01S 3/305; H01S 3/2256

(57) ABSTRACT

In an inertial containment fusion (ICF) system which uses a KrF laser, it is beneficial to perform pulse compression of the laser output to produce a higher-power, higher-intensity laser pulse at the target. Such pulse compression involves counter-propagating laser pump and seed beams. A short-pulse seed beam is amplified as energy is extracted from a long-pulse pump beam. Because such energy extraction is invariably incomplete, a fraction of the pump energy will exit the compression cell in the same direction as the optics used to create the seed beam. The invention involves a gas consisting of a noble gas such as neon or argon which may be excited by an electron beam to enhance absorption. By proper choice of gas, cell length, electron-beam excitation, and time delay, the residual pump beam may be absorbed almost entirely with less than 0.01% transmitted laser energy through the invention.

### CROSS REFERENCE TO RELATED APPLICATION

This application claims the benefit of U.S. Provisional Application No. 63/469,015 filed on May 25, 2023, which is incorporated herein by reference.

### BACKGROUND

It has long been known that excimer lasers, and particularly kryton-flouride (KrF) lasers, offer significant benefit for inertial laser fusion, due to their relatively short wavelengths, high pulse energies, and low cost, as noted in J. R. Murray, J. Goldhar, D. Eimerl, A. Szoke, “Raman Pulse Compression of Excimer Lasers for Applications to Laser Fusion,” IEEE Jour. Quant. Electron., Vol. QE-15, pp. 342-367 (1979). However, these benefits do not come without drawbacks, such as a relatively long pulse duration due to the limited peak intensity that is achievable with excimer lasers, due to a relatively low saturation intensity that is intrinsic to such lasers. To overcome this limitation, large-area excimer lasers may be desirable to increase the intensity×area product, which increases the total laser power. For example, a large-area excimer beam in a preferred embodiment might have a transverse area of 13.5 square meters, comprising 16×6 array of beamlets, each of which is 0.375×0.375 meters in transverse width. Additionally, and most relevant for this invention, is that the pulse can be made longer by extending the electron-beam excitation of the laser medium. A pulse length as long as 3 microsec is envisioned. This increases the power x pulse-duration product, which increases the total laser pulse energy. However, given a large pulse energy, which is defined as 1 to 10 MJ in preferred embodiments, the next challenge is to compress the pulse energy to a useful duration for ICF. In conventional systems, this pulse may be amplified by the extraction of the laser-beam energy with a long pulse duration using a nonlinear medium. Such energy extraction is not complete, so some of the pump energy will travel towards the optics and equipment that launched the counter-propagating seed beam. To avoid damage of such optics and equipment, one option is to use a near-counterpropagating pump and seed, so that the residual pump beam light misses the seed-launch optics and equipment. For example, the pump and seed beams could be at a relative angle of a few degrees from direct counter-propagation. However, this is impractical in some circumstances, because such a geometry may have a lower total gain and may lead to unacceptable non-uniformity of the amplified seed beam.

In conventional optical systems in which the optical pulse energy per unit area (fluence) is much lower, such isolation is often performed by polarization isolation, or by non-reciprocal optical components, such as a Faraday rotator. However, with ICF, the fluence is so high that such devices would not survive the incident laser. The aforementioned conventional state of the art can divert 1-10 joule/cm² of optical energy at 0.25-micron wavelength in the Oct. 9, 2010-5 second pulse length range. The switch presented here can absorb and thus divert 102-103 joules/cm² at the same wavelength and over the same pulse length range.

### SUMMARY

At times, it is impractical to use near-counter-propagating seed and pump pulses. Therefore, a “blocker” is often a useful and practical alternative for protecting the optics when the pump and seed beams must propagate within a few degrees of each other. It will be seen by analysis and simulation that such a blocker can “block” the residual pump beam, absorbing such pump-beam energy almost entirely with less than 0.01% transmitted laser energy through the invention. Such a blocker must deal with very high pump-laser pulse energy per unit area (fluence), so it must be windowless when the pump laser passes through. On the other hand, the gases chosen in the blocker represent potential contaminants, so there must be shutters to contain the gas in the blocker volume between laser pulses. In some cases (for some gases and laser profiles) the low-energy seed pulse will transmit but the high-energy seed pulse will be highly absorbed, as is well-known to occur in optical breakdown scenarios. In other cases, an electron-beam excitation is needed to enhance absorption at will when the excitation is applied. This triggerable absorption will also allow the passage of a lower-energy seed pulse but block (absorb) the passage of the higher-energy residual pump pulse at a slightly later time. The objective of this invention is to absorb or re-direct high-intensity light that would otherwise impinge on costly hardware, as might be needed when there are counter-propagating laser beams of high intensity.

A gas-filled blocker region is exemplarily described herein. A variety of mixtures may be employed within the gas-filled region, such as one atmosphere of a noble gas and additive gases. Many kinds of gases, such as N₂, neon, xenon, or argon, may be employed. The absorption or redirection of the high fluence laser beam energy by means of a switch is employed. The switch may be energized with electron beam irradiation and/or a discharge region. The switch would be energized after the passage of a low fluence pulse exiting from costly hardware and would then absorb the high fluence pulse that is heading toward the costly hardware. Alternatively, redirecting the high fluence laser beam may allow it to be absorbed in a separate region. For a passive switch, the seed beam may pass through the region with small loss, and afterwards the counter-propagating residual pump beam may be absorbed due to the same physical principles responsible for optical breakdown. Another means of redirection is amplified spontaneous emission (ASE) in a gaseous region. Another variant is to use multiphoton absorption that is tuned to the incident laser frequency. In this case, an appropriate atom or molecule is excited by the pump laser to a higher-lying electronic state that is subsequently photoionized and thereby energizes the blocker.

### BRIEF DESCRIPTION OF THE DRAWINGS

FIG. 1 shows a schematic diagram of the gas-filled blocker region with counter-propagating pump and seed laser.

FIG. 2 shows a schematic diagram of the seed laser beam passing through the gas-filled blocker region.

FIG. 3 shows a schematic diagram of the pump laser beam passing through the gas-filled blocker region.

FIG. 4 shows a schematic diagram of the gas-filled blocker region with discharge circuit.

FIG. 5 shows a flow diagram of the excitation and absorption pathways of the preferred embodiment using neon excited with an electron beam.

FIG. 6 plots a graph of the expected absorption per cm in steady-state versus electron density.

FIG. 7a plots a graph of the net transmission through the entire gaseous region versus time into the pulse without time delay.

FIG. 7b plots a graph of the net transmission through the entire gaseous region versus time into the pulse with time delay.

### SPECIFICATION

The term “approximately”, “about”, “near”, “roughly” refer to a given value ranging plus/minus 20%. For example, the phrase of “approximately 1 atmosphere” is intended to encompass a range of 0.8 to 1.2 atmospheres.

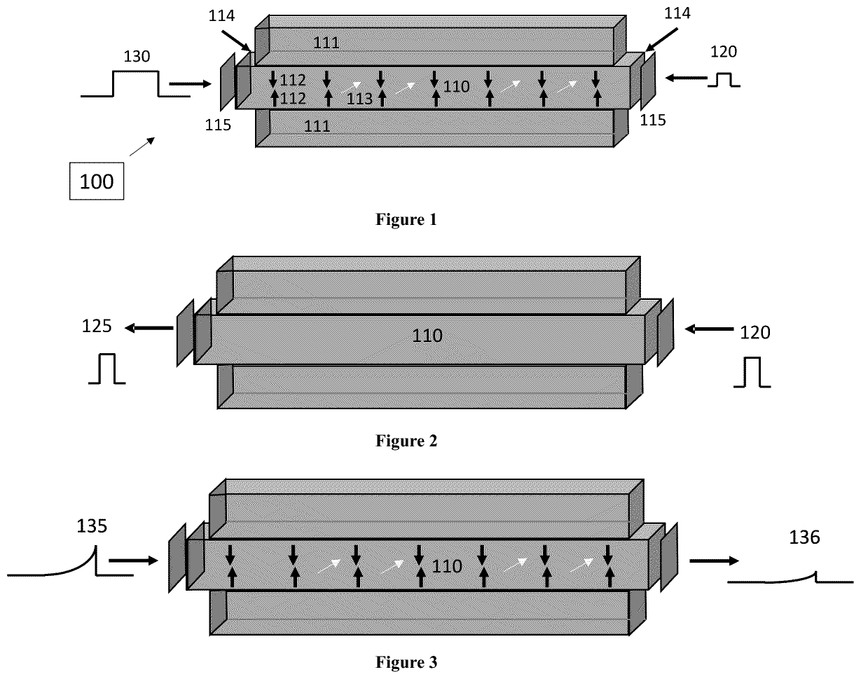

Referring to FIG. 1, a preferred embodiment 100 comprises: a gas-filled absorption region 110; optional electron-beams 111 to excite the gas volume with beams of electrons 112; an optional transverse gas flow 113 which might also include flow out the ends 114; a lower-energy seed laser beam 120 (for example: having a fluence of about 1 J/cm² or less) entering from the right; and a higher-energy pump laser beam 130 (for example: having a fluence of about 10 J/cm² or more) that later enters from the left.

When the system is not operational, there are shutters 115 on either end that aid in containment of the gas in region 110. When it is time for seed laser beam light 120 or pump laser beam light 130 to enter the region 110, the shutters 115 are automatically removed from the optical path by actuation devices (not shown). The transverse gas flow 113 aids in prevention of leakage to the external environment at this time. In a typical embodiment, the next step in the process is the introduction of a low-energy seed beam 120 into the gas-filled region 110.

As shown in FIG. 2, the intent of the invention is that the seed beam 125 remains substantially unaltered in both amplitude and phase as it passes through the blocker switch. In a typical embodiment as shown in FIG. 3, the residual high-power pump laser light 135 will begin to pass through the region 110 in about 200 nsec or less after the seed laser beam has passed through. The absorbing blocker switch 100 may then be energized with electron beam irradiation 112 in a preferred embodiment, then greatly reducing the energy of the output pump laser 136. The energy absorbed from the pump laser then resides in the gas-filled region, in addition to the energy deposited by the electron beam, which is then removed by means of a mechanical pump which causes gas flow 113. The energy removal process would typically require on the order of 1 second.

The gas-filled region 110 is approximately 10 meters in length by 1.2 meters in width and 1.2 meters in height for an ICF application. The gas-filled absorption region 110 nominally comprises neon at atmospheric pressure, but also may comprise a mixture of Ne, Ar, Xe, He, or N₂ at various partial pressures. Examples will be given below.

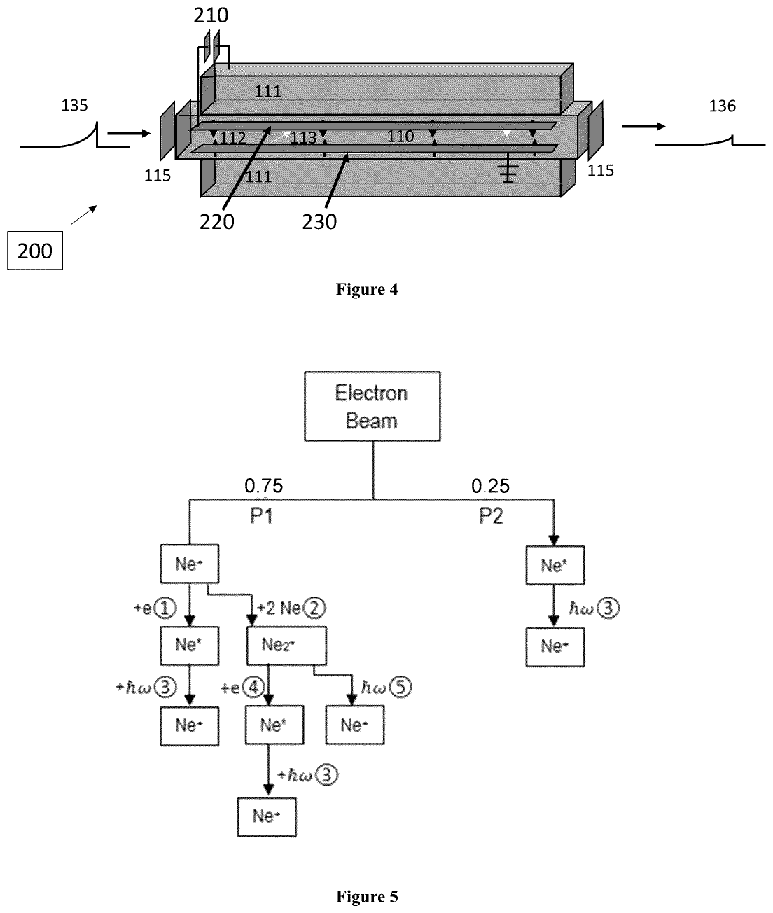

In an alternative embodiment 200 shown in FIG. 4, an optional discharge circuit 210 may be used to enhance electron density, with a cathode 220 and anode 230. The cathode and anode may have an array of holes that allow the nominal electron beams 111 to excite the whole absorption volume.

The embodiment 100 shown in FIG. 1 may also be operated as a passive blocker switch, for which electron beams or a discharge circuits are not required. In this alternative method of operation, the preferred gas is xenon or molecular nitrogen. In this case the seed beam 120 may pass through the region with negligible loss and the exiting beam 125 will be negligibly altered. Then afterwards the counter-propagating residual pump laser beam at high energy may be absorbed due to the same physical principles responsible for optical breakdown. In media exhibiting optical breakdown, low-power beams can be propagated through and remain unaltered whereas high-power beams will be self-focused and absorbed.

In another alternative method of operation, the high-power pump beam may be scattered and thus redirected by copious amplified spontaneous emission (ASE) in an appropriate gaseous region. One such gas which might be used in this method is N₂, which will have copious spontaneous Raman emission. In yet another alternative method, multiphoton absorption may be used to absorb the pump laser light. In this alternative xenon is a candidate gas. In this alternative, the pump laser wavelength may be tuned to match the multiphoton transition to enhance absorption. In this case, an appropriate atom or molecule is excited by the pump laser to a higher-lying electronic state that is subsequently photoionized and thereby energizes the blocker.

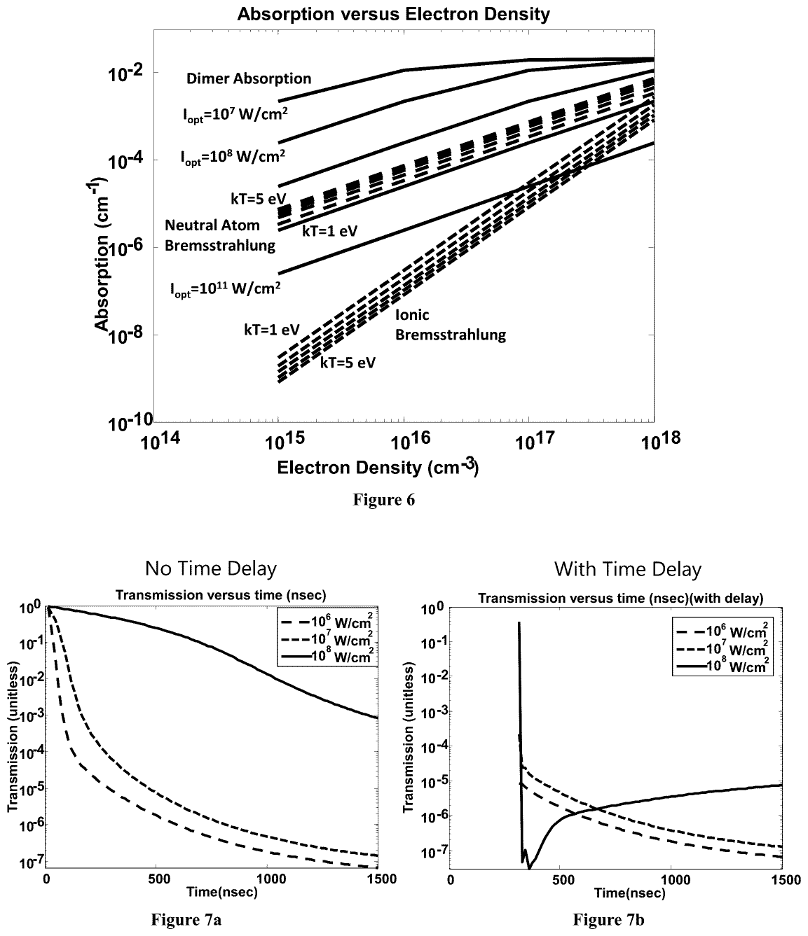

In the preferred embodiment using neon, the excitation and absorption pathways are shown in FIG. 5. Examples of the expected performance based on simulation are shown in FIGS. 6, 7a and 7b. The simulations are based on rate equations that are well-known to those skilled in the art. FIG. 6 shows the expected absorption per cm in steady-state versus electron density. There are three principal types of absorption that are expected and shown using the various markers (i.e., solid line, long-dashed line, short-dashed line) depicted in FIG. 6: absorption by the Ne² dimer (solid lines), absorption by bremsstrahlung of the neutral Ne atoms (long-dashed lines), and bremsstrahlung by the ionic Ne atoms (short-dashed lines). FIGS. 7a & 7b shows the net transmission through the entire gaseous region versus time into the pulse. The pump laser pulse intensity is a parameter. FIG. 7a depicts a fairly good performance with no time delay between the time the electron beam irradiates the medium and the time the laser arrives. However, in FIG. 7b, a better performance is found if a time delay of 100 nsec is used because the ion and dimer concentrations have time to grow as the slowing, scattered electrons continue to excite the medium.

Various possible embodiments can be envisioned in the scope of this invention. In the preferred embodiment, the gas is pure neon at 1 atmosphere pressure. In this embodiment, an electron beam is needed to excite the neon gas into absorbing states. In a variant of this embodiment, mixtures such as 0.99 Ne/0.01 Xe by pressure would provide a high degree of thermally induced ionization if heated to 1 to 2 eV and have a controllable absorption depending on the mixture. In this variant, a KrF laser output may be tuned to the 3-photon absorption line of xenon to enhance absorption and heat the medium, after which bremsstrahlung absorption takes over. In another embodiment, the gas is pure xenon at 1 atmosphere pressure that relies on the low-breakdown threshold of the xenon gas to absorb and scatter the incident laser light. In this embodiment, electron-beam excitation may be helpful but is not required. In yet another embodiment, the blocker consists of all molecular nitrogen (N₂), and the type of scattering is nonlinear rotational Raman scattering at pressures from 0.1 to 1.5 atmospheres. In this embodiment, no gas excitation is needed, and the mechanism is both scattering and absorption.

The specifications displayed and described herein are examples only, and not intended to limit the general principles of the invention.

1. A system for blocking a high-energy laser while allowing a lower-energy laser to pass through a central region, comprising
a central region containing one or more gases;
a seed laser source that emits a seed laser beam into the central region;
a first mechanical shutter that is located between the seed laser source and the central region;
a pump laser source that emits a pump laser beam into the central region in an opposite direction from a propagation direction of the seed laser source after the central region receives the seed laser source;
a second mechanical shutter located between the pump laser source and the central region; and
a mechanical pump to move the one or more gases through the central region, transversely to the direction of the propagation of the seed laser source and the pump laser source, and to remove the energy deposited in the central region,
wherein the one or more gases within the central region absorbs energy from the pump laser.

2. The blocker of claim 1, further comprising:
an electron beam source to excite the one or more gases in the central region.

3. The blocker of claim 2, further comprising:
a discharge circuit to enhance the excitation of the electron density within the one more gases in the central region.

4. The blocker of claim 3, wherein the discharge circuit further comprises a cathode and anode.

5. The blocker of claim 1, wherein the one or more gases nonlinearly absorbs the energy of the pump laser and the electron beam source.

6. The blocker of claim 5, wherein the nonlinearly absorption is by multiphoton absorption.

7. The blocker of claim 6, further comprising:
a wavelength tuner to tune the wavelength of the pump laser to an atomic or molecular line to further enhance the scattering cross section.

8. The blocker of claim 5, wherein the one or more gases is xenon.

9. The blocker of claim 2, wherein the one or more gases is neon.

10. The blocker of claim 5 wherein the one or more gases is molecular nitrogen.

11. A method for blocking a high-energy laser while allowing a lower-energy laser to pass through a central region, comprising:
filling a central region of the blocker with one or more gases;
opening a first mechanical shutter, located between a seed laser source and the central region;
launching a lower energy seed laser beam from the seed laser source into a central region;
after the lower energy seed laser beam reaches the one or more gases in the central region, opening a second mechanical shutter, located between a pump laser source and the central region;
launching a high energy pump laser beam from the pump laser source into the central region in an opposite direction of the seed laser beam;
a mechanical pump to move the one or more gases through the central region, transversely to the direction of the propagation of the seed laser source and pump laser source, to remove the energy deposited in the central region,
wherein the one or more gases within the central region absorbs energy from the pump laser.

12. The blocker of claim 11, further comprising launching an electron beam source into the central region to excite the one or more gases.

13. The method of claim 12, further comprising enhancing the excitation of the electron density with a discharge circuit within the one more gases in the central region.

14. The method of claim 13, wherein the discharge circuit further comprises a cathode and anode.

15. The method of claim 11, further nonlinearly absorbing the energy of the pump laser and the electron beam source.

16. The method of claim 15, wherein the nonlinearly absorption is by multiphoton absorption.

17. The blocker of claim 16, further comprising tuning the wavelength of the pump laser to an atomic or molecular line to further enhance the absorbing cross section.

18. The blocker of claim 15, wherein the one or more gases is xenon.

19. The blocker of claim 12, wherein the one or more gases is neon.

20. The blocker of claim 15, wherein the one or more gases is molecular nitrogen.
